(19) United States
(12) Patent Application Publication
(10) Pub. No.: US 2016/0214573 A1
(43) Pub. Date: Jul. 28, 2016

(54) ACCESS CONTROL SYSTEM FOR A MOTOR VEHICLE

(71) Applicant: JOHNSON CONTROLS AUTOMOTIVE ELECTRONICS SAS, Cergy Pontoise Cedex (FR)

(72) Inventors: Gregoire LAGABE, Paris (FR); Laurent MONTAROU, Asnieres sur Seine (FR)

(21) Appl. No.: 14/901,091

(22) PCT Filed: Jun. 25, 2014
(86) PCT No.: PCT/EP2014/063388

§ 371 Date: Mar. 31, 2016

(30) Foreign Application Priority Data
Jun. 28, 2013 (FR) 13/01530

(51) Int. Cl. B60R 25/24

(52) U.S. Cl. CPC B60R 25/245

(57) ABSTRACT

An access control system for activating functionalities of a motor vehicle using a remote control includes: the remote control; an access control unit located in the motor vehicle, configured to communicate with the remote control via radiofrequency signals; one or more components for locating a user via a location of the remote control by determining the position of the remote control in an environment close to the motor vehicle or inside the motor vehicle, the environment being divided into a plurality of predetermined zones; one or more components for associating the determined position of the remote control with a single zone of the plurality of predetermined zones; and a detection unit, the detection unit being configured to detect a control event, the control event being provided for activation of at least one functionality of the motor vehicle.

### CROSS-REFERENCE TO RELATED APPLICATIONS

This application is a U.S. National Phase application under 35 U.S.C. §371 of International Application No. PCT/EP2014/063388, filed on Jun. 25, 2014, and claims benefit to French Patent Application No. 13/01530, filed on Jun. 28, 2013. The International Application was published in French on Dec. 31, 2014, as WO 2014/207040 A1 under PCT Article 21(2).

### FIELD

The present invention relates to an access control system for a motor vehicle, notably for activating functionalities of the motor vehicle using radiofrequency signals emitted and/or received by a remote control and by an access control unit located in the motor vehicle, the access control system allowing for a selective access control as a function of the position of the user.

### BACKGROUND

Remote controls—also called manual emitters—are generally known for different vehicle functions, the remote controls being incorporated notably in a vehicle key or a key fob. Such remote controls are used for so-called remote keyless access (or remote keyless entry) functions, which emit radiofrequency signals that make it possible to verify the authorization of the user to perform functionalities of the motor vehicle, notably to open and/or to close vehicle door locks, vehicle shutters and vehicle hoods, to trigger an alarm, called panic alarm, of an alarm installation of the vehicle, start up an engine driving the vehicle, open and close windows of the vehicle and sunroofs, and automatically open and close sliding doors of the vehicle. Furthermore, such remote controls used for keyless access system functions of a vehicle are called keyless go systems.

In particular, access control systems are known from the prior art in which a person confirms his or her identity as user having an access authorization by the possession of a key or a key card. These access control systems are characterized by the name “keyless-entry/keyless-go”, it being understood that no traditional mechanical action key is used and that the authorization can extend, in addition to access to the vehicle, also to its use for the driving thereof.

In the case of these systems, the presence of a key card is checked after a sensor incorporated in the vehicle has detected a control action. The door handles are for example equipped with switches, the actuation of which is detected by the system, after which a radiofrequency signal is emitted by the vehicle, by which radiofrequency signal the key card is activated so as to produce a response and its presence can consequently be determined.

In the presence of an authorization, a desire to access is acceded to by the fact that the control system controls electromechanical actuators for the unlocking of door locks, and does so, as a function of a preselection, for all of the doors present, or, optionally, only for the door with the handle where the actuation has been detected.

As it happens, it is disadvantageous that it is normally necessary for the user to physically interact with at least one element of the access control system. The sense of convenience for the user, who possibly has to actuate the door handle several times in order to access the vehicle, is thus reduced.

### SUMMARY

In an embodiment, the invention provides an access control system for activating functionalities of a motor vehicle using a remote control. The access control system includes: the remote control; an access control unit located in the motor vehicle, configured to communicate with the remote control via radiofrequency signals; one or more components for locating a user via a location of the remote control by determining the position of the remote control in an environment close to the motor vehicle or inside the motor vehicle, the environment being divided into a plurality of predetermined zones; one or more components for associating the determined position of the remote control with a single zone of the plurality of predetermined zones; and a detection unit, the detection unit being configured to detect a control event, the control event being provided for activation of at least one functionality of the motor vehicle. The detection unit is configured such that the detection unit inputs the control event or not as a function of the single zone associated with the determined position of the remote control and/or as a function of the determined position of the remote control.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a motor vehicle and a pattern of zones associated with the motor vehicle as well as a remote control for an access control system according to the present invention;

FIG. 2 schematically illustrates ways in which the motor vehicle according to the present invention can be used;

FIG. 3 schematically illustrates another representation of the motor vehicle with the pattern of zones as in FIG. 1, and a remote control for an access control system according to the present invention in the situation in which a gesture from the user is used to actuate a functionality of the motor vehicle;

FIGS. 4 and 5 schematically illustrate another representation of the motor vehicle with the pattern of zones as in FIG. 1, and a remote control for an access control system according to the present invention in the situation in which a cell phone of the “smart phone” type is used as a part of the detection unit; and

FIGS. 6 and 7 schematically illustrate another representation of the motor vehicle with the pattern of zones as in FIG. 1, and a remote control for an access control system according to the present invention in the situation in which the same gesture is used to trigger a different functionality of the motor vehicle as a function of the position of the user.

### DETAILED DESCRIPTION

Embodiments of the present invention provide an improved remote control system for vehicle functions.

In an embodiment, the invention provides an access control system for a motor vehicle, notably for activating functionalities of the motor vehicle using radiofrequency signals emitted and/or received by a remote control and by an access control unit located in the motor vehicle, said access control system comprising, apart from the remote control and the access control unit:
one or more components for locating a user via a location of the remote control by determining the position of the remote control, the location of the remote control being provided in the environment close to the motor vehicle or inside the motor vehicle, the environment close to the motor vehicle and inside the motor vehicle being divided into a plurality of predetermined zones,
one or more components making it possible to associate the determined position of the remote control with a single zone of the plurality of predetermined zones,
a detection unit, the detection unit being configured to detect a control event on the part of the user, the control event being provided for the activation of at least one functionality of the motor vehicle, the detection unit being configured in such a way that the detection unit inputs the control event or not as a function of the single zone associated with the determined position of the remote control and/or as a function of the determined position of the remote control.

The invention comprises one or more components for locating a user relative to the vehicle, such that the position of the user relative to the vehicle (for example according to the direction and the distance) can be determined. The one or more components may include a network of antennas for locating a radio signal emanating from a key card that the user is in possession of or be formed by image sensors which allow for an identification of the user and consequently, at the same time, a detection of authorization, or similar.

The invention further comprises one or more components whereby the outside close region is divided into a pattern of mutually adjacent zones. The latter may be, for example, a memory module in which are stored ranges of values for the coordinates. A location information item can consequently be associated with one of the ranges of values, that is to say one of the zones.

The invention thus makes it possible to determine whether the remote control (and thus the user of the motor vehicle) is located in the close environment of the motor vehicle. Correspondingly, a control unit can control actuators in a targeted manner in order to assist by anticipation a presumed action of the user corresponding to the movement. Only when the remote control is located in the close environment of the motor vehicle, a detection unit is controlled such that the detection unit is activated to detect a control event. Normally, the access control system according to the present invention comprises a plurality of detection units, notably one detection unit for each predetermined zone or even several detection units for a single predetermined zone. According to the present invention, the detection unit inputs the control event when the remote control is detected as being located in the close environment of the motor vehicle, and the detection unit does not input the control event when the remote control is not detected as being located in the close environment of the motor vehicle. When a number of detection units are present in the access control system, it is preferable for only the detection unit to be activated (that is to say the detection of the detection unit is activated such that the control event can be input) which is associated with the zone in which the remote control is detected.

A person skilled in the art will understand that access in the meaning of the present invention is not limited to the region of the driver or of the passengers. It can also concern separate regions such as the trunk, the engine compartment or similar.

According to the present invention, it is advantageously possible for not only the position of the user to be determined but also the movement of the user. Thus, a plurality of detection units can be taken into consideration to detect the control event.

According to a preferred embodiment according to the present invention, it is preferable for the control event to be an acoustic or vocal event from the user.

Thus, it is advantageously possible for the user to control the inventive system using his or her voice or using an acoustic noise. In the case where the control event is an acoustic or vocal event from the user, the detection unit is preferably a microphone or an acoustic wave detector or an acoustic wave sensor.

According to another preferred embodiment according to the present invention, it is preferable for the control event to be a gesture event from the user.

Thus, it is advantageously possible for the user to control the inventive system using a gesture of a part of his or her body, for example a gesture of his or her arm and/or a gesture of his or her hand and/or a gesture of his or her leg and/or a gesture of his or her head. In the case where the control event is a gesture event from the user, the detection unit is preferably a camera or an optical detector or an optical sensor making it possible to detect the gesture from the user.

According to another preferred embodiment according to the present invention, it is preferable for the detection unit to be positioned in the motor vehicle.

Through such an embodiment of an access control system, it is advantageously possible according to the present invention for the detection unit to be able to be positioned flexibly in an external part of the motor vehicle. Notably, it is particularly preferable according to the present invention to use optical sensors as detection unit which are used for other functionalities of the motor vehicle, for example collision prediction sensors (predicting collisions with other cars and/or pedestrians).

According to another preferred embodiment according to the present invention, it is preferable for the detection unit to be at least partially positioned outside the motor vehicle, that is to say at least a part of the detection unit is positioned outside the motor vehicle, this part being notably a sensor carried by the user such as, for example, his or her cell phone of the “smart phone” type or his or her laptop computer of the “tablet” type which usually include acceleration sensors and/or magnetic sensors and/or acoustic sensors.

Thus, it is advantageously possible for—for example—the sensors of a cell phone of the “smart phone” type (or portable computers in cell phone form) or of a portable computer of the “tablet” type to be incorporated in the access control system: when the user (with his or her remote control) approaches close enough to the motor vehicle, a radiofrequency connection (notably of short range such as, for example, a Bluetooth connection) is established between, on the one hand, the access control system, and, on the other hand, the cell phone of the “smart phone” type or the portable computer of the “tablet” type, and the sensors of the cell phone and/or of the portable computer are activated to input the control event from the user.

According to another preferred embodiment according to the present invention, it is preferable for radiofrequency signals to be exchanged between the remote control and the access control unit in order to check the authorization of the remote control to activate functionalities of the motor vehicle.

Through such an embodiment of an access control system, it is advantageously possible according to the present invention to implement the access control to the motor vehicle simply and effectively.

Other features and advantages of the invention will become apparent on reading the following description of a non-limiting particular embodiment of the present invention.

The invention will be better understood from the following description, which relates to preferred embodiments, given as non-limiting examples and explained with references to the attached schematic drawings.

The parts which correspond with one another in all the figures are provided with the same reference numbers.

FIG. 1 schematically illustrates a motor vehicle 2 and a pattern of zones associated with the motor vehicle 2 as well as a remote control 1 for an access control system according to the present invention. In the pattern of zones associated with the motor vehicle, the zone limits are indicated by unbroken lines.

The access control system for the motor vehicle 2 according to the present invention is notably provided to activate functionalities of the motor vehicle 2. This is normally done using radiofrequency signals which are emitted and/or received by a remote control 1 and by an access control unit (not represented in the figures) located in the motor vehicle 2.

The zone limits are indicated, in FIG. 1, by unbroken lines. The zones are indicated in FIG. 1 by the designations “zone 1”, corresponding to a first zone, “zone 2”, corresponding to a second zone, “zone 3”, corresponding to a third zone, “zone 4”, corresponding to a fourth zone, “zone 5”, corresponding to a fifth zone, “zone 6”, corresponding to a sixth zone, and “zone 7”, corresponding to a seventh zone.

The access control system comprises, apart from the remote control 1 and the access control unit, one or more components for locating a user via a location of the remote control 1 by the determination of the position of the remote control 1. The location of the remote control 1 is provided in the close environment of the motor vehicle 2 or inside the motor vehicle 2. The first zone in FIG. 1 corresponds to a zone of the door of the driver of the motor vehicle 2. The second zone in FIG. 1 corresponds to a zone of the left rear door of the motor vehicle 2. The third zone in FIG. 1 corresponds to a zone of the door of the passenger of the motor vehicle 2. The fourth zone in FIG. 1 corresponds to a zone of the right rear door of the motor vehicle 2. The fifth zone in FIG. 1 corresponds to a zone behind the motor vehicle 2. The sixth zone in FIG. 1 corresponds to the interior of the motor vehicle 2. The seventh zone in FIG. 1 corresponds to a zone of the or above the trunk of the motor vehicle 2. An eighth zone in FIG. 1 is not indicated by a reference symbol, but corresponds to a zone of the tank filler cap of the motor vehicle 2.

The representation of the zones in FIG. 1 comprises—apart from the unbroken lines indicating the zones or rather the communication radius of the zones—two broken lines in the first, second, third, fourth, fifth, sixth and seventh zones and passing almost completely around the motor vehicle: a first inner line, that is to say closer to the motor vehicle 2, and a second outer line, that is to say further away from the motor vehicle 2. The first broken line serves as a limit for opening the motor vehicle when a user—that is to say the remote control 1—approaches the motor vehicle 2. The second broken line serves as a limit for closing the motor vehicle 2 when a user—that is to say the remote control 1—moves away from the motor vehicle 2.

According to the present invention, it is possible to locate a user via a location of the remote control 1 by the determination of the position of the remote control 1 around the motor vehicle (that is to say in a close environment of the motor vehicle 2, for example a few meters away from the motor vehicle 2) or inside the motor vehicle 2.

Using the relatively accurate location of the remote control 1 (or of the user), it is advantageously possible according to the present invention to associate a single zone which is the current zone of the remote control (out of the plurality of the zones mentioned above) with each given instant. The (relatively accurate) determined position of the remote control 1 can then be associated with a single zone (that is to say the current zone) out of the plurality of local zones (that is to say the first, second, third, fourth, fifth, sixth, seventh and eighth zones). The accuracy of determination of the position of the remote control 1, notably around the motor vehicle 2, is of the order of a few decimeters or of the order of a few centimeters, notably from one centimeter to 100 centimeters, preferably from 2 centimeters to 80 centimeters, preferably from 5 centimeters to 50 centimeters.

According to the present invention, the access control system comprises a detection unit, the detection unit being configured to detect a control event on the part of the user, the control event being provided for the activation of at least one functionality of the motor vehicle, the detection unit being configured in such a way that the detection unit inputs the control event or not
as a function of the single zone associated with the determined position of the remote control, and/or
as a function of the determined position of the remote control.

Thus, according to the present invention, the detection unit is activated (to input the control event) only in the situation in which the remote control is detected within one of the predetermined zones around the motor vehicle (or inside).

According to the present invention, it is preferable for a sequential control to form part of the access control unit, the sequential control being configured to execute, several times repeatedly, the locating of the remote control 1 and the association of the remote control 1 with a single zone of the plurality of local zones. This repeated execution of the sequential control generates a sequence of information items regarding the position of the remote control 1 also making it possible to detect a direction of movement of the remote control 1.

The access control unit comprises a plurality of actuators in the motor vehicle or the access control unit is associated with a plurality of actuators in the motor vehicle. The actuators are, for example, associated with the locks of the doors of the motor vehicle.

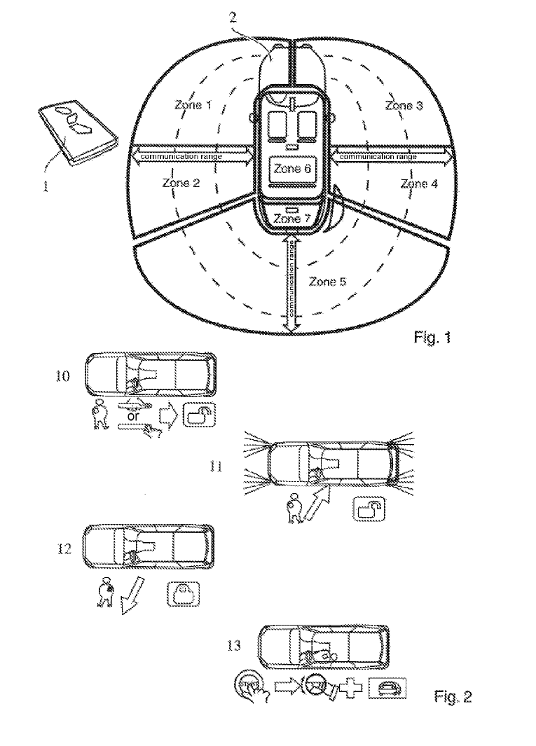

FIG. 2 schematically illustrates ways in which the motor vehicle according to the present invention can be used. The reference symbol 10 corresponds to a situation in which a user of the motor vehicle must not only approach the motor vehicle, but must also press on a control element to open the motor vehicle. The reference symbol 11 corresponds to a situation in which a user of the motor vehicle must only approach the motor vehicle to open the motor vehicle. The reference symbol 12 corresponds to a situation in which a user of the motor vehicle must only move away from the motor vehicle to close the motor vehicle. The reference symbol 13 corresponds to a situation in which a user of the motor vehicle must only press on a button to start the engine of the motor vehicle.

FIG. 3 schematically illustrates another representation of the motor vehicle with the pattern of zones as in FIG. 1, as well as a remote control for an access control system according to the present invention in the situation in which a gesture from the user is used to actuate a functionality of the motor vehicle. This gesture may be, for example, lifting a leg when the user is located in the fifth zone (behind the trunk of the motor vehicle), and serves to actuate the functionality of opening the trunk of the motor vehicle.

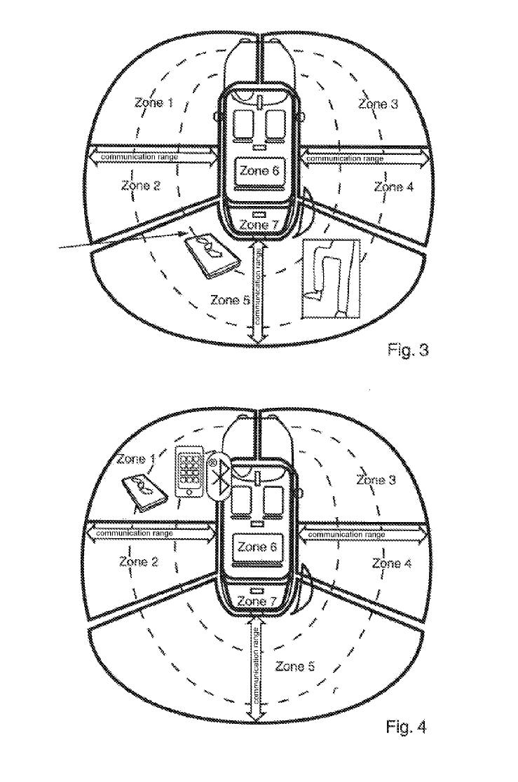

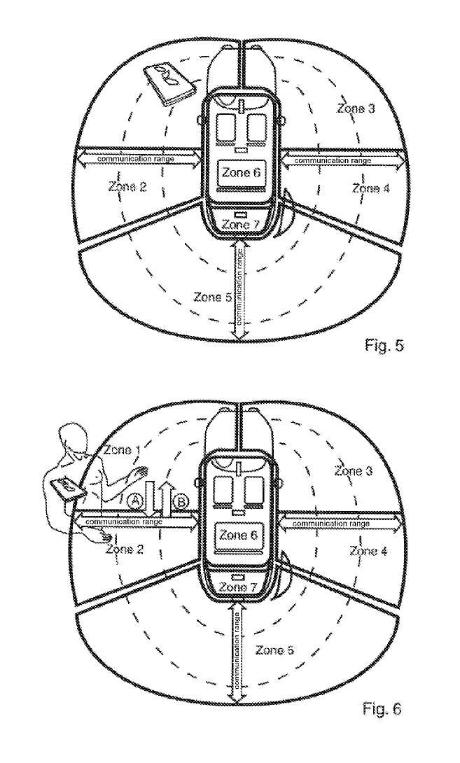

FIGS. 4 and 5 schematically illustrate another representation of the motor vehicle with the pattern of zones as in FIG. 1, as well as a remote control for an access control system according to the present invention in the situation in which a cell phone of the “smart phone” type is used as a part of the detection unit. A Bluetooth link is established between the cell phone of the “smart phone” type (or a portable computer, for example of the “tablet” type) and the access control system according to the present invention when the user approaches the motor vehicle. Afterwards, the detectors or the sensors in the cell phone or the computer are used as sensors for inputting the control event from the user, for example an acoustic event and/or a gestural event and/or a combined event.

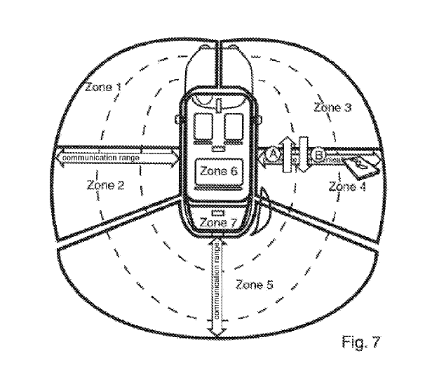

FIGS. 6 and 7 schematically illustrate another representation of the motor vehicle with the pattern of zones as in FIG. 1, as well as a remote control for an access control system according to the present invention in the situation in which the same gesture (for example a horizontal motion from the user) is used to trigger a different functionality of the motor vehicle as a function of the position of the user: when the user is located on the left side of the motor vehicle (represented in FIG. 6) the same gesture (horizontal motion from left to right or from right to left) serves to open or to close a door (for example a sliding door) on the left side of the motor vehicle, and when the user is located on the right side of the motor vehicle (represented in FIG. 7), the same gesture (horizontal motion from right to left or from left to right) serves to open or to close a door (for example a sliding door) of the right side of the motor vehicle.

One of the particular features of the present invention is that the motor vehicle scans the presence of the remote control 1 in the close environment of the motor vehicle and the detection of the authorized remote control in this close environment wakes up one or more detection units of the vehicle (for example: a camera and/or a microphone) and/or one or more communication units (for example one or more Bluetooth units) of the motor vehicle with appliances such as smart phones. The vehicle components necessary for the activation of the actions of the gestural, vocal or sound controls (in the case of the waking up of detection units) or of the actions of the controls performed via the appliance like the smart phone will be
either woken up by the detection or communication units
or directly by the detection of an authorized remote control in the close environment of the vehicle.

In addition to the waking-up concept, the detection and/or communication units are kept active as long as the remote control is in a close environment of the motor vehicle and the battery life is deemed satisfactory by the energy management system of the motor vehicle. They are deactivated if the remote control leaves the close environment and/or if the energy management system of the motor vehicle deems the life of the battery to be no longer satisfactory (this may correspond to timer functions which depend on the consumptions of the detection/communication units and vehicle members activated).

Effectively, in the case of the waking up of detection units, the actions of the gestural, vocal or sound controls can be as a function of the zones and/or of the position of the remote control.

Similarly, in the case of the waking up of communication units with appliances like smart phones, the control actions performed via the use of these appliances (for example: smart phone application using or not using gestural/vocal or sound controls) can be as a function of the zones and/or position of the remote control.

The actions of the gestural, vocal or sound controls can be those of FIG. 2, but can also be—in another example—functions such as opening/closing openings (the trunk, a sunroof) or windows.

According to the present invention, the detection and communication units can be used for functions other than those linked to the gestural, oral or sound controls: for example, the cameras may form part of standalone driving assistant systems such as blind spot detection, trajectory detection and/or control (lane departure warning) and/or the rearview camera.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An access control system for activating functionalities of a motor vehicle using a remote control the access control system comprising:
the remote control;
an access control unit located in the motor vehicle, configured to communicate with the remote control via radiofrequency signals;
one or more components for locating a user via a location of the remote control by determining the position of the remote control in an environment close to the motor vehicle or inside the motor vehicle, the environment being divided into a plurality of predetermined zones;
one or more components for associating the determined position of the remote control with a single zone of the plurality of predetermined zones; and
a detection unit, the detection unit being configured to detect a control event, the control event being provided for activation of at least one functionality of the motor vehicle, wherein the detection unit is configured such that the detection unit inputs the control event or not as a function of the single zone associated with the determined position of the remote control and/or as a function of the determined position of the remote control.

2: The access control system according to claim 1, wherein the control event is an acoustic or vocal event from the user.

3: The access control system according to claim 1, wherein the control event is a gesture event from the user.

4: The access control system according to claim 1, wherein the detection unit is positioned in the motor vehicle.

5: The access control system according to claim 1, wherein the detection unit is partially implemented in a mobile device; and
wherein a radiofrequency link, is established between the mobile device and the access control unit when the user approaches the motor vehicle with the mobile device.

6: The access control system according to claim 1, wherein the detection unit is at least partially positioned outside the motor vehicle.

7: The access control system according to claim 1, wherein, between the remote control and the access control unit, radiofrequency signals are exchanged for verifying the authorization of the remote control to activate functionalities of the motor vehicle.

8: The access control system according to claim 5, wherein the radiofrequency link is a Bluetooth link.
